(19) United States
(12) Patent Application Publication
(10) Pub. No.: US 2018/0122223 A1
(43) Pub. Date: May 3, 2018

(54) Surveillance Monitoring System

(71) Applicant: Mihai Simon, Aurora, CO (US)

(72) Inventor: Mihai Simon, Aurora, CO (US)

(21) Appl. No.: 15/793,161

(22) Filed: Oct. 25, 2017

Related U.S. Application Data
(60) Provisional application No. 62/416,610, filed on Nov. 2, 2016.

(51) Int. Cl. G08B 29/18; G08B 13/196; H04N 7/18

(52) U.S. Cl. CPC G08B 29/185; H04N 7/183; G08B 13/19673

(57) ABSTRACT

A system of identity association for security monitoring. An example system includes an onsite single device platform. An event server is configured to receive an alarm from a monitoring service of an event at a property being monitored. A video converter is configured to format a video signal from the property being monitored for issuing to the event server. The event server notifies an end-user device of the alarm and providing the end-user device with the formatted video signal to determine whether the alarm is a false alarm or an actual alarm. A communications server brings data in an open format and pairs with video from the onsite single device platform.

### PRIORITY CLAIM

This application claims the priority benefit of U.S. Provisional Patent Application No. 62/416,610 filed Nov. 2, 2016 titled “Surveillance Monitoring System” of Mihai Simon, hereby incorporated by reference for all that it discloses as though fully set forth herein.

### BACKGROUND

Security systems may monitor a breach, such as a door or window opening or being broken. Alarms are typically sent to a monitoring service, who then either contacts the property owner to confirm whether the alarm is a false alarm or an actual alarm. If the alarm is an actual alarm, or if the property owner cannot confirm that the alarm is a false alarm (e.g., the property owner is off-site), then the monitoring service typically contacts emergency personnel (e.g., police). However, this results in the police being called on false alarms. The police may refuse to respond to alarms and/or charge a fee to the property owner if they are called on too many false alarms.

### BRIEF DESCRIPTION OF THE DRAWINGS

FIG. 1 shows an example of systems and operations which may be implemented surveillance monitoring.

### DETAILED DESCRIPTION

Alarm companies install burglar alarm systems that detect intrusion and other abnormal conditions. This detection takes place via sensors communicating with an on-premise control panel. The control panel then utilizes various communication paths to send the event to a receiver located on the premises of a central monitoring station or dispatch company. The alarm company receives the alarm events and follows protocol notifying the responsible parties. They may or may not have access to some video, usually a single camera or a still picture.

Furthermore, a security company may connect surveillance cameras to a DVR (Digital Video Recorder) or NVR (network Video Recorder). This DVR or NVR is most often located on-premises—it has processing and storage for the video, and it stores high quality video that requires a lot of storage and a high bandwidth, it has a monitor, mouse and keyboard for local control and display (to play back video, export the footage, print images, etc.). There are some companies out there that have set up their own NVR “in the cloud”, and are offering a service that allows the camera to connect directly to the “cloud based NVR”—avoiding the need for a local DVR or NVR. This has one significant limitation—it requires a high bandwidth connection from the customer site and the more cameras you have, the more speed you need. As such, this service can only be offered in small quantities, one or two cameras typically, with lower video quality, or no motion picture at all, just still images—hence the dispatchers currently have limited video.

Surveillance monitoring is disclosed, the system and method which may be configured to identify or assist in identifying actual alarms as opposed to false alarms, thereby reducing police being called to false alarms.

In an example, surveillance monitoring may be implemented as part of or with a security system. The security system may include building security devices such as a burglar alarm. The security system may be configured with various other hardware components, including a universal power supply (UPS) and battery backup for continuous access and monitoring. The hardware components may be located in one or more enclosure. The security system may also include communications via a local control panel and/or remote means (e.g., a networked computer or mobile device).

The security system may include a closed circuit television (CCTV) and/or other video monitoring equipment. The video component may display events in real-time and/or record events on a local and/or remote storage device.

Example surveillance monitoring systems and methods disclosed herein utilize as input a live video feed and/or video recording to assist in identifying actual alarms versus false alarms.

Before continuing, it is noted that as used herein, the terms “includes” and “including” mean, but is not limited to, “includes” or “including” and “includes at least” or “including at least.” The term “based on” means “based on” and “based at least in part on.”

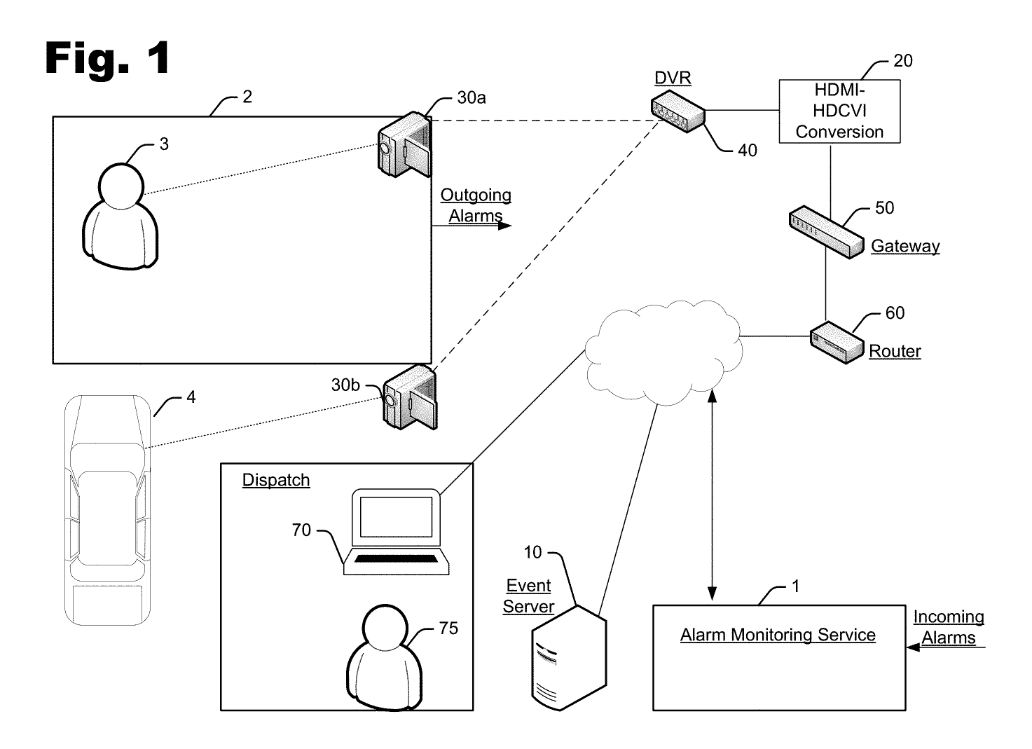

FIG. 1 shows an example of systems and operations which may be implemented for surveillance monitoring. The example surveillance monitoring system includes an event server 10 and a video converter 20.

An alarm system may be installed at the property 2, for example including motion sensor(s), door and window sensors, and video. In an example, video may include one or more cameras, such as cameras 30a and 30b. Accordingly, the end-user can view video from multiple locations to assist in making a determination whether the alarm is an actual alarm or a false alarm. For example, if the end-user can see an image of a person 3 in the building 2, but cannot make out who the person is (e.g., is it a burglar or an employee?), and the end-user can see an image of a vehicle 4 in the parking lot outside the building 2, and the end-user knows the vehicle belongs to one of the employees, then the end-user can make the determination that the person 3 in the building is an employee. Of course, the end-user may wait and continue monitoring until person 3 is better visible, or the end-user may call person 3 to confirm their location. But in the meantime, the police do not need to be called as it would likely be a false alarm if person 3 is indeed an employee.

The event server 10 is configured to receive an alarm from a monitoring service 1 of an event at a property 2 being monitored. In an example, the event server 10 pairs information about the alarm with video from the property 2 being monitored. The event server 10 may be inter-operable between different types of alarm systems. The event server 10 provides access to stored video corresponding to a time of the alarm and/or live feed video. The event server 10 may associate a priority to the alarm (e.g., a fire may be a higher priority than a motion detector). The event server 10 pushes the alarm and video the end-user device 70 so that the end-user 75 does not need to waste time logging into a remote system to view video at the property 2 being monitored.

The video converter 20 is configured to format a video signal from the property being monitored for issuing to the event server. The video signal may be video from one or more camera 30a, 30b, e.g., fed to a DVR or other video recording device 40. The video may be formatted (e.g., converted, compressed and/or combine multiple feeds) by the converter 20. A gateway 50 may provide the formatted video signal from the video converter 20 via the router 60 to the event server 10.

It is noted that the end-user 75 and end-user device 70 may be the property owner (or other person concerned with security of the property), a dispatch office, a security office, and/or the monitoring service. Notifications may be in the form of a phone call, text, and/or email to the end-user 75. The end-user 75 may then access any suitable device (e.g., a smart phone or tablet, PC, etc.) to view the video. The notifications may include information about the alarm paired with the video (e.g., pairing by the event server). Video may include a live feed and/or recorded video. In an example, multiple videos are displayed on the same screen so that the end-user can see multiple areas of the property simultaneously (e.g., the location of person 3 on the property 2, and the parking area). The video may be encoded and/or compressed (e.g., for transmission via internet protocol (IP)) to reduce network load and/or provide faster viewing of the video.

In use, the event server 10 notifies an end-user device 70 of the alarm and provides the end-user device 70 with the formatted video signal so that the end-user 75 can determine whether the alarm is a false alarm or an actual alarm when an alarm is received by the monitoring service. In an example, the event server 10 receives a determination from the end-user device 70 that the alarm is either a false alarm, an actual alarm, or unknown. The event server 10 may issue the determination from the end-user device 70 to the monitoring service 1 for appropriate action.

In an example, program code executable on the router 60 connects to the event server 10 regardless of the relative locations of the property 2 being monitored, the location of the event server 10, and the location of the end-user device 70.

The system disclosed herein does not take video from the cameras directly. Instead, all cameras go to the local DVR or NVR, and then connect the HDMI output of the DVR/NVR (that would otherwise go to the local monitor) to a high definition/high resolution encoder. The encoder takes the video being displayed on the monitor and makes it available for distribution via IP connectivity. This in turn aggregates multiple cameras onto one HDMI Stream. In an example, the DVR's always display all cameras connected to it (by default and in most use cases) which then allows us to say “we can view all cameras from your site, not just one or two”.

An example system also connects a Keyboard/Mouse emulator to the local DVR/NVR, that is accessible via the Internet, to give the user remote control of the local DVR/NVR as if standing in front of it. Accordingly, the system can simulate a guard standing in front of the local DVR/NVR when an alarm comes in—but remotely.

Output from the Mouse/Keyboard emulator, as well as the High Definition Encoder, is sent as IP traffic to a local gateway. This gateway is pre-programmed to automatically connect to a cloud server (the event or management server). No matter where it is installed in the world, it connects to the cloud. There is no need for a person on site to program the network or make any adjustments—it's literally plug and play.

An example system also adds input and control points from this gateway or encoder. These control points are controlled from the management server (central location or dispatch room) to control lights and thermostats.

An example system may also aggregate multiple Encoded streams, as if a customer had multiple DVR's/NVR's to monitor.

An example system may also add supplementary monitoring devices connected through this gateway to monitor site conditions such as temperature, humidity, electrical consumption, and other sensors and devices that communicate with the management server, all communicating via the IP gateway.

An example system may also include all components enclosed in a secure enclosure. This enclosure may include a power supply and battery backup, and may include HDMI or VGA signal splitters or Network Switches.

All of the above are the “Site components” enclosed in an onsite single device platform (e.g., a secure “box”) that enable quick, instant connectivity from a DVR/NVR, monitor output with aggregated camera views, with no site configuration, and provide additional inputs and outputs for additional features and functionality.

In addition, program code enables the system to receive events from the central monitoring station in an open format. This includes e-mail and text messages. The video from the site (using the box) is paired with the alarms received (in an open format) from the central monitoring station receivers and generate alarms, cause other actions to take place, control doors and other functions.

The whole package is a video alarm verification system that is able to receive video from just about any type of DVR/NVR and alarms from just about any central station receiver equipment—with little to no on-site setup and low bandwidth consumption.

Before continuing, it should be noted that the examples described above are provided for purposes of illustration, and are not intended to be limiting. Other devices and/or device configurations may be utilized to carry out the operations described herein.

In addition, the operations shown and described herein are provided to illustrate example implementations. It is noted that the operations are not limited to the ordering shown. Still other operations may also be implemented.

Example operations may include receiving an alarm from a monitoring service at an event server, the alarm related to an event at a property being monitored; formatting a video signal from the property being monitored; issuing the formatted video signal to the event server; notifying an end-user device of the alarm; and providing the end-user device with the formatted video signal to determine whether the alarm is a false alarm or an actual alarm.

It is noted that the examples shown and described are provided for purposes of illustration and are not intended to be limiting. Still other examples are also contemplated.

1. A system of identity association for security monitoring, comprising:
an onsite single device platform; and
a communications server that brings data in an open format and pairs with video from the onsite single device platform.

2. The system of claim 1, further comprising:
an event server configured to receive an alarm from a monitoring service of an event at a property being monitored; and
a video converter configured to format a video signal from the property being monitored for issuing to the event server, the event server notifying an end-user device of the alarm and providing the end-user device with the formatted video signal to determine whether the alarm is a false alarm or an actual alarm.

3. The system of claim 1, further comprising a DVR providing the video signal from at least one video camera to the video converter.

4. The system of claim 1, further comprising a gateway and a router, the gateway providing the formatted video signal from the video converter via the router to the event server.

5. The system of claim 4, further comprising program code executable on the router to connect to the event server regardless of the relative locations of the property being monitored, the event server, and the end-user device.

6. The system of claim 1, wherein the end-user device outputs multiple camera views on a single screen.

7. The system of claim 1, wherein the event server pairs information about the alarm with video from the property being monitored.

8. The system of claim 1, wherein the event server is inter-operable between different types of alarm systems.

9. The system of claim 1, wherein the event server provides access to stored video corresponding to a time of the alarm and/or live feed video.

10. The system of claim 1, wherein the event server associates a priority to the alarm.

11. The system of claim 1, wherein the event server pushes the alarm and video the end-user device so that the end-user does not need to waste time logging into a remote system to view video at the property being monitored.

12. The system of claim 1, wherein the event server receives a determination from the end-user device that the alarm is either a false alarm, an actual alarm, or unknown.

13. The system of claim 12, wherein the event server issues the determination from the end-user device to the monitoring service.

14. A system of identity association for security monitoring, comprising:
an onsite single device platform;
an event server configured to receive an alarm from a monitoring service of an event at a property being monitored;
a video converter configured to format a video signal from the property being monitored for issuing to the event server, the event server notifying an end-user device of the alarm and providing the end-user device with the formatted video signal to determine whether the alarm is a false alarm or an actual alarm; and
a communications server that brings data in an open format and pairs with video from the onsite single device platform.

15. The system of claim 14, further comprising:
a gateway and a router, the gateway providing the formatted video signal from the video converter via the router to the event server; and
program code executable on the router to connect to the event server regardless of the relative locations of the property being monitored, the event server, and the end-user device.

16. The system of claim 14, wherein the end-user device outputs multiple camera views on a single screen.

17. The system of claim 1, wherein the event server:
pairs information about the alarm with video from the property being monitored; and
provides access to stored video corresponding to a time of the alarm and/or live feed video.

18. The system of claim 1, wherein the event server:
associates a priority to the alarm; and
pushes the alarm and video the end-user device so that the end-user does not need to waste time logging into a remote system to view video at the property being monitored.

19. The system of claim 1, wherein the event server:
receives a determination from the end-user device that the alarm is either a false alarm, an actual alarm, or unknown; and
issues the determination from the end-user device to the monitoring service.

20. A security monitoring method, comprising:
receiving an alarm from a monitoring service at an event server, the alarm related to an event at a property being monitored;
formatting a video signal from the property being monitored;
issuing the formatted video signal to the event server;
notifying an end-user device of the alarm; and
providing the end-user device with the formatted video signal to determine whether the alarm is a false alarm or an actual alarm.
